(19) United States
(12) Patent Application Publication
(10) Pub. No.: US 2015/0165970 A1
(43) Pub. Date: Jun. 18, 2015

(54) REDUCTANT TANK FILL NOTIFICATION SYSTEM

(71) Applicant: Caterpillar Inc., Peoria, IL (US)

(72) Inventors: Ethan Tevis, Bloomington, IL (US); Matthew A. Hartman, Bloomington, IL (US); Michael C. Gentle, Maroa, IL (US)

(73) Assignee: Caterpillar Inc., Peoria, IL (US)

(21) Appl. No.: 14/633,172

(22) Filed: Feb. 27, 2015

(51) Int. Cl. B60Q 9/00

(52) U.S. Cl. CPC B60Q 9/00

(57) ABSTRACT

A method of notifying an operator that a reductant tank associated with a machine is in a full state during filling of the reductant tank. The method includes receiving a signal indicative of a current level of the reductant within the reductant tank from an electronic control module of the machine. The method also includes comparing the current level of the reductant with a predetermined threshold. The method further includes determining if a full tank status of the reductant tank exists corresponding to the current level of the reductant being greater than the predetermined threshold. The method further includes triggering a notification based on the determination of the full tank status condition of the reductant tank. The notification is provided in such a manner to alert an operator positioned outside of the machine of the full tank status of the reductant tank.

### TECHNICAL FIELD

The present disclosure relates to a notification system for a machine, and more particularly to the notification system associated with filling operation of a reductant tank of the machine.

### BACKGROUND

In an effort to reduce exhaust emissions stemming from operation of internal combustion engines powering work machines, such machines generally have an “on-board” aftertreatment system. The typical aftertreatment system includes a reductant reservoir, a reductant injector, and reductant delivery lines for injecting or dosing a liquid reductant into an exhaust conduit. Typical on-board reductant reservoir sizes may have a capacity of several gallons, with the reservoir size being dependent upon the rate of the reductant or diesel fuel consumption by the machine. Based on usage of the reductant in the reductant reservoir, the reductant reservoir requires periodic refilling from an external reductant supply. It may be seen that reductant reservoirs do not include any gauges or indicators to make an operator filling the reservoir from outside of the machine, aware of a current level of the reductant in the reductant reservoir. Hence, due to the lack of fill indication level, the operator may overfill the reductant reservoir, sometimes causing the excess reductant to spill from the reductant reservoir. Moreover, it is undesirable to spill the reductant or come in contact with the liquid or vapor due to over-filling the reductant tank.

U.S. Pat. No. 7,053,782, hereinafter referred as the '782 patent, relates to a fuel overflow alarm system. The fuel overflow alarm system includes a filler inlet switch which operates a full tank detection sensor and a full tank indicator, when a filler inlet to a fuel tank is opened. The full tank indicator informs an operator when the detection output corresponding to a full tank occurs. However, the addition of the tank fill alarm system of the '782 patent adds expense to the cost of the machine and may not be adequate for reductant tank fill operation.

### SUMMARY OF THE DISCLOSURE

In one aspect of the present disclosure, a method of notifying an operator that a reductant tank associated with a machine is in a full state during filling of the reductant tank is disclosed. The method includes receiving a signal indicative of a current level of the reductant within the reductant tank from an electronic control module of the machine. The method also includes comparing the current level of the reductant with a predetermined threshold. The method further includes determining if a full tank status of the reductant tank exists corresponding to the current level of the reductant being greater than the predetermined threshold. The method further includes triggering a notification based on the determination of the full tank status condition of the reductant tank. The notification is provided in such a manner to alert an operator positioned outside of the machine of the full tank status of the reductant tank.

Other features and aspects of this disclosure will be apparent from the following description and the accompanying drawings.

### BRIEF DESCRIPTION OF THE DRAWINGS

FIG. 1 is a perspective view of an exemplary machine including a reductant tank fill notification system, according to one embodiment of the present disclosure;

FIG. 2 is a block diagram of the notification system present on the machine of FIG. 1, according to one embodiment of the present disclosure; and

FIG. 3 is a flowchart of a method of notification for a reductant tank associated with the machine of FIG. 1, according to one embodiment of the present disclosure.

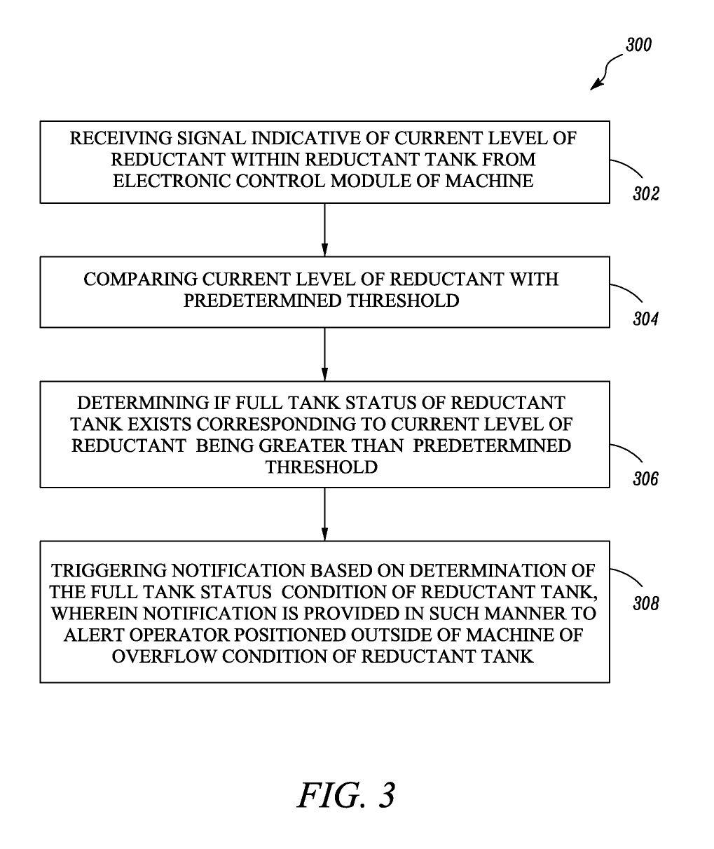

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

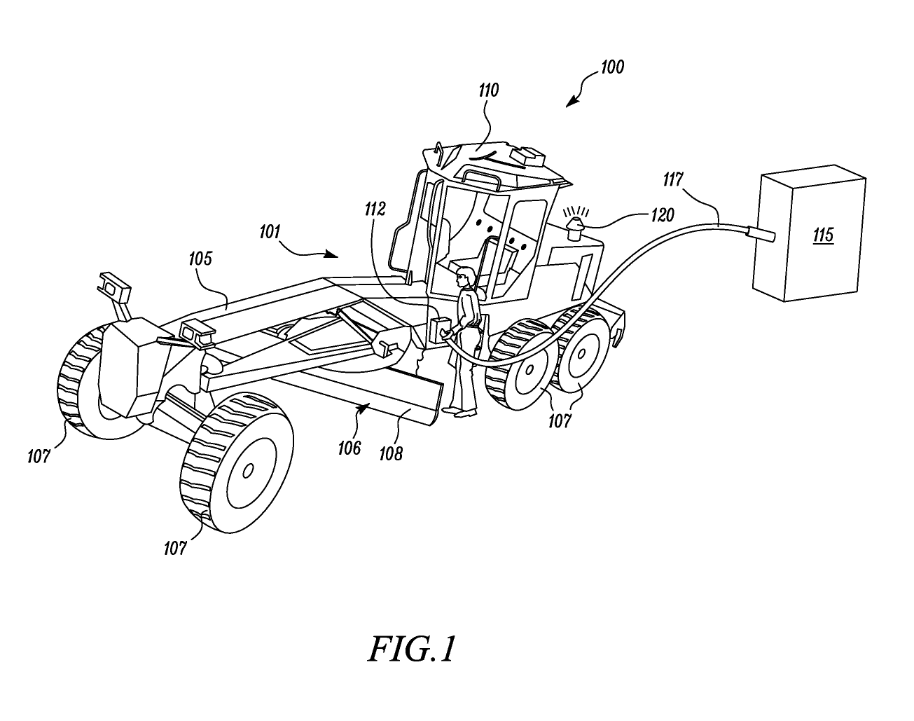

FIG. 1 shows a motor grader; hereinafter machine 100, according to an aspect of the current disclosure. In other embodiments, the machine 100 may be associated with an industry, such as, construction, mining, forestry, agriculture, waste management, material handling, transportation, and so on. Accordingly, in other embodiments, the machine 100 may be a haul truck, a mining truck, and so on. The machine 100, for example, may be a motorgrader which is typically used to “grade” or level earth for roadways or any other purpose contemplated for such machine. The machine 100 includes frame 101 having a beam 105 coupled to the ground engaging members or wheels 107.

The machine 100 further includes an implement 106 for performing various earth moving operations, such as ground leveling. The implement 106 is rotatably supported on the beam 105 and includes a blade 108 which is designed to engage the ground to provide the grading or leveling operation. The machine 100 further includes an engine to power the machine 100 as is customary.

The engine may be located towards the rear of the machine 100 and is typically mounted on the frame 101 as is customary. The engine drives the wheels 107 via a transmission (not shown). The transmission may produce multiple output speed ratios or a continuously variable speed ratio between the engine and the ground engaging members 107. Further, an operator cab 110 is supported on the frame 101. The operator cab 110 includes various operator controls, along with displays and indicators used to operate the machine 100 and convey information to an operator.

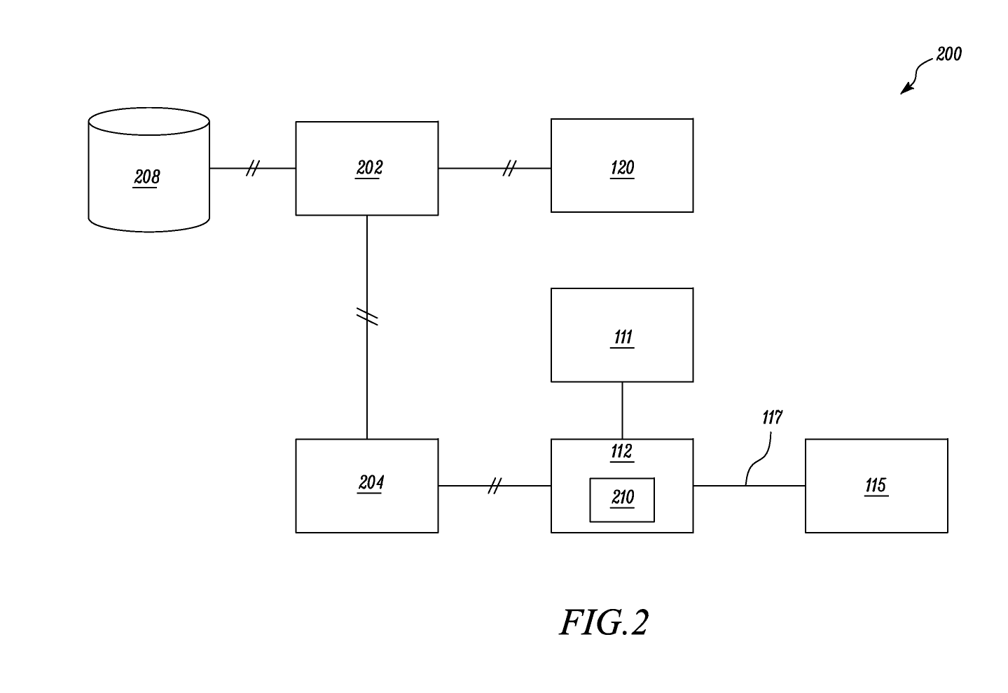

The engine (not shown) also includes an exhaust aftertreatment system 111 (see FIG. 2). The aftertreatment system 111 includes a reductant delivery module (not shown). The reductant delivery module is designed to inject a reductant into the exhaust gas flow. The reductant may be a fluid such as, a Diesel Exhaust Fluid (DEF), including urea. Alternatively, the reductant may include ammonia or any other reducing agent. The reductant delivery module includes a reductant tank 112, a pump (not shown), and a reductant injector (not shown). The aftertreatment system 111 may further include a Selective Catalytic Reduction (SCR) module (not shown) provided downstream of the reductant delivery module with respect to a reductant flow direction in the aftertreatment system 111. The SCR module is configured to reduce a concentration of NOx present in the exhaust gas flowing therethrough. The aftertreatment system 111 is fluidly connected to a downstream portion of the exhaust plumbing such as the exhaust manifold (not shown), for example, of the engine. The exhaust gas flow contains emission compounds that may include Nitrogen Oxides (NOx), unburned hydrocarbons, particulate matter, and/or other compounds.

Further, the amount of reductant associated with the reductant tank 112 may decrease upon usage and operation of the machine 100. Such decrease of the reductant requires replenishing or refilling of the reductant tank 112 with the reductant. The replenishing or refilling of the reductant tank 112 is done under supervision of the operator of the machine 100. As shown in FIG. 1, the operator fills the reductant tank 112 with the reductant from an external source 115. The external source 115 may be any mobile or immobile source to facilitate supplying the reductant to the reductant tank 112. In one example, the external source 115 may be a supply tank with a metered fill control system (not shown) and may be available at a DEF fill station, for example. The supply of the reductant to the reductant tank 112 from the external source 115 is achieved by connecting a hose 117 to an opening of the reductant tank 112. The hose 117 may be any conduit or pipeline capable of transferring the reductant from the external source 115 to the reductant tank 112. In one embodiment, the reductant tank 112 may be filled using a splash fill method, wherein a nozzle connected at one end of the hose 117 is used to introduce the reductant into the reductant tank 112. Other filling techniques may also be utilized for transferring the reductant into the reductant tank 112.

Referring to FIG. 2, a notification system 200 includes a control tool 204 associated with the reductant tank 112. This control tool 204 may be embodied as a reductant control unit associated with the reductant tank 112. The control tool 204 is communicably coupled to level sensors 210 associated the reductant tank 112. The level sensors 210 may be any known sensing device associated with the reductant for monitoring a current level of the reductant present inside the reductant tank 112. In one example, the level sensors 210 may embody a mechanical float. Alternatively, any other level sensing device may be utilized in association with the reductant tank 112. Based on a drop or decrease in the current level of the reductant in the reductant tank 112, the external source 115 may be mechanically coupled to the reductant tank 112 via the hose 117 to supply the reductant into the reductant tank 112 on a connection thereof.

Although a single reductant tank 112 is shown in the accompanying figures, a person of ordinary skill in the art will appreciate that based on the system requirements; the machine 100 may include multiple such reductant tanks 112. Further, either a single control tool 204 may be associated with the multiple reductant tanks 112, or multiple control tools 204 may be present on the machine 100 for each of the reductant tanks 112.

As shown in FIG. 2, the control tool 204 is electrically coupled to an electronic control module (ECM) 202. The ECM 202 may be configured to generate signals indicative of the operating parameters of the various electrical components and systems of the machine 100. The ECM 202 is also coupled to a database 208. The database 208 may be any memory hardware configured for storing and retrieving data. The ECM 202 may retrieve data from and store data in the database 208. The database 208 is configured to store a predetermined threshold associated with the reductant tank 112. This predetermined threshold may be determined based on parameters associated with the reductant tank 112, for example, capacity of the reductant tank 112. In an event when the current level of the reductant in the reductant tank 112 exceeds the predetermined threshold, a full tank status of the reductant tank 112 is achieved. In an alternate embodiment, the database 208 may be coupled to the control tool 204 associated with the reductant tank 112.

During the fill operation, the operator of the machine 100 connects the hose 117 to the reductant tank 112, thereby connecting the external source 115 and the reductant tank 112 for transfer of the reductant into the reductant tank 112. The control tool 204 monitors the current level of the reductant inside the reductant tank 112, via the level sensors 210. The control tool 204 may further send these signals to the ECM 202. The ECM 202 may retrieve the predetermined threshold from the database 208, and compare the current level of the reductant with the predetermined threshold. If the current level of the reductant exceeds the predetermined threshold, the ECM 202 determines that the full tank status of the reductant tank 112 is met.

The ECM 202 is further electrically coupled to the indication device 120. On determination of the full tank status of the reductant tank 112, the ECM 202 sends command signals to the indication device 120 for activation thereof. The indication device 120 is any sound producing device, such as, an alarm, a buzzer, a speaker, a horn, and so on. Alternatively, the indication device 120 may be a visual indicator producing device, such as, an LED lamp, a screen, and so on. As mentioned earlier, the indication device 120 is positioned on the exterior frame 101 of the machine 100 and is generally positioned proximate to the location at which the operator performs the fill operation. The indication device 120 is located such that it is easily viewable or audible by the operator while performing the fill operation.

Thus, the indication device 120 provides a notification to the operator of the full tank status of the reductant tank 112 while the fill operation is being performed. Based on the activation of the indication device 120, the operator may take further corrective action to prevent an overflow of the reductant tank 112.

The ECM 202 may include a computing microprocessor or any other similar microprocessor known in the art for performing various processes and operations or may include a general purpose computer or computing platform selectively activated or reconfigured to provide required functionality. The ECM 202 of the machine 100 may be in communication with various electrical components (not shown) of the machine 100, for example, with electrical subsystems (not shown) comprised of sensors, circuits, actuators, or any other known component which may interface with, for example, the power source, or the implement 106 to animate the machine 100. Alternatively, the present disclosure contemplates a plurality of ECMs for use in the machine 100, as is customary for the purpose of powering the machine 100 and its subsystems

### INDUSTRIAL APPLICABILITY

The present disclosure relates to an indication device 120 provided on an exterior portion of the machine 100, such that an operator positioned outside the machine 100 is made aware of a level of the reductant in the reductant tank 112 while performing a reductant fill operation. In one embodiment, the indication device 120 is configured to notify the operator that the reductant tank 112 has reached the full state during the fill operation.

The process includes filling the reductant, for example the DEF (Diesel exhaust fluid) mentioned earlier, into the reductant tank 112 from the external source 115. The filling of the reductant is done in view of the decrease in the level of the reductant in the reductant tank 112 with time and use.

At step 302, the method 300 includes receiving a signal indicative of the current level of the reductant within the reductant tank 112 from the electronic control module 202 (ECM 202) of the machine 100. At step 304, the method 300 includes comparing the current level of the reductant with the predetermined threshold. At step 306, the method 300 includes determining if the full tank status of the reductant tank 112 exists corresponding to the current level of the reductant being greater than the predetermined threshold. At step 308, the method 300 further triggers the notification based on the determination of the full tank status of the reductant tank 112.

The notification, from the indication device 120, is provided in such a manner to alert the operator positioned outside of the machine 100 of the full tank status of the reductant tank 112. Accordingly, the overflow of the reductant tank 112 may be prevented. The notification system 200 can be easily retrofitted with conventional machine designs. Further, operation and implementation of the method 300 and the notification system 200 as described is easy and involves low costs, as the method 300 and the notification system 200 can be worked in communication with existing electronic control modules (ECM) 202 of the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of notifying an operator that a reductant tank associated with a machine is in a full state during filling of the reductant tank, the method comprising:
receiving a signal indicative of a current level of the reductant within the reductant tank from an electronic control module of the machine;
comparing the current level of the reductant with a predetermined threshold;
determining if a full tank status of the reductant tank exists corresponding to the current level of the reductant being greater than the predetermined threshold; and
triggering a notification based on the determination of the full tank status condition of the reductant tank, wherein the notification is provided in such a manner to alert an operator positioned outside of the machine of the full tank status of the reductant tank.
